(19) United States
(12) Patent Application Publication
(10) Pub. No.: US 2006/0141260 A1
(43) Pub. Date: Jun. 29, 2006

(54) Sandwich composite material using an air-laid process and wet glass

(76) Inventors: Enamul Haque, Novi, MI (US); Terry Cheney, Northville, MI (US); Arthur Blinkhorn, Fenton, MI (US)

Correspondence Address: OWENS CORNING, 2790 COLUMBUS ROAD, GRANVILLE, OH, 43023, US

(21) Appl. No.: 11/025,147

(22) Filed: Dec. 29, 2004

(51) Int. Cl. B32B 27/36; B32B 27/40; B32B 27/30; B32B 27/32

(52) U.S. Cl. 428/412; 428/423.1; 428/500; 428/522; 428/523; 428/457; 428/537.1; 428/537.5; 156/62.2

(57) ABSTRACT

A sandwich composite material formed of a core layer positioned between first and second skin layers is provided. Either the core layer or the first and second skin layers are formed of a composite material that includes reinforcement fibers and organic fibers. Preferably, the reinforcing fibers are wet use chopped strand glass fibers. The composite material may be formed by opening the reinforcement fibers, blending the reinforcement and organic fibers, forming the reinforcement and organic fibers into a sheet, and bonding the sheet. The core layer and first and second skin layers may be attached by adhesives or resin tie layers. The sandwich composite material may include a facing layer affixed to an exposed major surface of one or both of the first and second skin layers. The strength, stiffness, and load deflection of the sandwich composite material may be modified by changing the amount and/or type of fibers present.

### TECHNICAL FIELD AND INDUSTRIAL APPLICABILITY OF THE INVENTION

The present invention relates generally to composite products, and more particularly, to a sandwich composite material that includes at least one layer formed of reinforcing fibers and organic fibers that can be used as a facing material or as a core material.

### BACKGROUND OF THE INVENTION

Glass fibers are useful in a variety of technologies. For example, glass fibers are used as reinforcements in polymer matrices to form glass fiber reinforced plastics or composites. Glass fibers have been used in the form of continuous or chopped filaments, strands, roving, woven fabrics, non-woven fabrics, meshes, and scrims to reinforce polymers. Glass fibers are commonly used as reinforcements in polymer matrices to form glass fiber reinforced plastics or composites because they provide dimensional stability as they do not shrink or stretch in response to changing atmospheric conditions. In addition, glass fibers have high tensile strength, heat resistance, moisture resistance, and high thermal conductivity.

One use for fiberglass reinforced plastic composites is in a sandwich structural panel. A sandwich structural panel is a combination of thin, high strength facing layers on each side of a thicker, lightweight core material that provides insulative properties, acoustic dampening properties, and structural properties. The core material absorbs the sheer forces generated by loads and distributes then over a large area. As a result, the core layer should be sufficiently stiff and have good shear strength. The facing layers are typically formed of a fiberglass reinforced plastic (FRP). Typically, the core and facing layers are bonded with adhesives or mechanical fasteners so that they can act as a load bearing unit.

Examples of conventional sandwich structural panels and are set forth below.

U.S. Pat. No. 4,459,334 to Blanpeid et al. discloses a composite panel that includes a core of foamed plastic material and a skin on at least one of its faces that is formed of a two-ply material of aluminum foil bonded to a mat of randomly oriented glass fibers. Panels formed of the core material and the two-ply skins are asserted to have excellent thermal insulation and fire retardant properties.

U.S. Pat. No. 4,910,067 to O'Neill discloses a structural material formed of a thermoplastic layer, a layer of fibrous material spaced from the thermoplastic layer, and a foam core disposed in the space between the layers. A resin impregnates and holds the layer of fibrous material together to form a fiber reinforced resin structure. The foam core and the fiber reinforced resin structure are integrally formed from a core material capable of having a foamed character and a resinous character.

U.S. Pat. No. 4,937,125 to Sanmartin et al. discloses a sandwich structure formed of a core interposed between an external skin and an internal skin designed to be resistant to impact and thermal aggressions.

U.S. Pat. No. 5,186,999 to Brambach describes a sheet-like sandwich material formed of a core material sandwiched between two reinforced top layers. The core layer is a thermoplastic foamed material or a material having a honeycomb structure. The top layers are formed of a thermoplastic synthetic plastic material reinforced with fibers. At least one local reinforcement that is a plastic material is injected under pressure into the core layer through one of the top layers.

U.S. Pat. No. 5,460,865 to Tsotsis describes a hybrid panel formed of a combination of a thin upper honeycomb core and a lower honeycomb core of equal or lower density then the upper core disposed around a thin lightweight interlayer. The combination of honeycomb cores and the lightweight interlayer is positioned within two outer skins.

U.S. Pat. No. 6,743,497 to Ueda et al. discloses a sandwich panel having a honeycomb core, a front surface layer, and a rear surface layer sandwiching the honeycomb core on its upper and lower surfaces. At least one of the front surface layer and the rear surface layer is made of a fiber reinforced plastic that uses a phenolic resin as a matrix.

U.S. Pat. No. 6,753,061 to Wedi discloses a flexible sandwich material that is formed of a center layer and one or two outer layers. The center layer is made of a polymeric synthetic material that is flexible and exhibits a honeycomb structure. The outer layers are formed of hardened mortar that is made flexible by synthetic additives, and that have as their core a fibrous web material.

U.S. Patent Publication No. 2003/0197400 A1 to Preisler et al. discloses sandwich type reinforced composite inner roof panels. The inner roof panel includes an upper skin made of a reinforced thermoplastic material, a cellular core made of a thermoplastic material, and a bottom skin made of a reinforced thermoplastic material.

U.S. Patent Publication No. 2003/0205917 A1 to Preisler discloses sandwich type load floors. The load floor includes a load bearing upper skin made of a reinforced thermoplastics material, an upper skeletal frame structure of reinforcing slates, each of which is made of a reinforced thermoplastic composite or pultrusion, a cellular core made of a thermoplastic material, a lower skeletal frame structure of reinforcing slats (reinforced thermoplastic composite or pultrusion), and a bottom skin made of a reinforced thermoplastic material.

Although there are numerous sandwich structural panels in existence in the art, none of the existing sandwich panels provide sufficient strength, stiffness, load deflection, and sufficient sound attenuating properties or the ability to tune the panel to meet the desired strength and acoustic requirements. Thus, there exists a need for sandwich composite materials that exhibit superior sound attenuating properties, improved structural and thermal properties, and that are lightweight and low in cost.

### SUMMARY OF THE INVENTION

It is an object of the present invention to provide a method of forming a sandwich composite material that includes positioning a core layer between major surfaces of a first skin layer and a second skin layer and affixing the core layer to the first and second skin layers. In at least one exemplary embodiment, the first and second skin layers are formed of a composite material that includes dehydrated reinforcement fibers and organic fibers. The composite material forming the first and second skin layers may be the same or different. In at least one other exemplary embodiment, the core layer is formed of the composite material. The composite material may be formed by opening bales of wet reinforcement fibers and removing at least a portion of the water present in the wet reinforcement fibers to form dehydrated reinforcement fibers. The dehydrated reinforcement fibers are blended with organic fibers, such as in a high velocity air stream, to form a substantially homogenous mixture of the reinforcement and organic fibers. The mixture is then transferred to a sheet former and formed into a sheet. At least some of the dehydrated reinforcement fibers and organic fibers are bonded to form a composite material. Preferably the reinforcing fibers are wet use chopped strand glass fibers. A facing layer or surface covering may be affixed to an exposed major surface of one or both of the first and second skin layers.

It is also an object of the present invention to provide a sandwich composite material that includes at least one layer formed of a composite material that includes dehydrated reinforcement fibers and organic fibers. The sandwich composite material is formed of a core layer positioned between first and second skin layers. In at least one exemplary embodiment, the first and second skin layers are formed of a composite material and the core layer may be a foam, balsa wood, paper, cardboard, aluminium, nomex, or glass reinforced thermoplastics (GMT). In at least one other exemplary embodiment, the core layer is formed of a composite material and the first and second skin layers are composite sheets or polymer sheets. The core layer and first and second skin layers may be attached by adhesives, tie layers, or other commonly known fixation technologies such as ultrasonics or vibration welding. A facing layer or surface covering may be affixed to an exposed major surface one or both of the first and second skin layers.

It is an advantage of the present invention that strength, stiffness, load deflection, and acoustic requirements of the sandwich composite material may be altered or improved by the specific combination of fibers present in the composite material, and can therefore be tailored to meet the needs of a particular application. For example, the composite material provides the ability to optimize and/or tailor the physical properties (such as stiffness and/or strength) of the sandwich composite material needed for specific applications by altering the amount and/or type of the reinforcing and/or organic fibers used in the composite material.

It is another advantage of the present invention that the composite material provides the ability to optimize and/or tailor the physical properties of the sandwich composite material (such as stiffness, load deflection, or strength) needed for specific applications altering the weight of the reinforcement and/or fibers, by changing the reinforcement fibers content and/or length or diameter of the reinforcement fibers, or by altering the fiber length and/or denier of the organic fibers used in the composite material.

It is a further advantage of the present invention that composite materials formed by the process described herein have a uniform or substantially uniform distribution of fibers, thereby providing improved strength as well as improved acoustical and thermal properties, stiffness, load deflection, and impact resistance to the sandwich composite material.

It is yet another advantage of the present invention that when wet use chopped strand glass fibers are used as the reinforcing fiber material, the glass fibers may be easily opened and fiberized with little generation of static electricity due to the moisture present in the glass fibers.

It is a further advantage of the present invention that a composite material formed using wet use chopped strand glass fibers in a dry-laid process such as described herein has a higher loft (increased porosity). The increased porosity decreases the density of the composite material and, at the same time, provides increased relative stiffness and sound absorption.

It is also an advantage that the wet use chopped strand glass fibers used in the dry-laid process described herein are less expensive to manufacture than dry chopped fibers and, as a result, permits the sandwich composite material to be manufactured at lower costs.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a flow diagram illustrating steps for using wet reinforcement fibers in a dry-laid process according to at least one exemplary embodiment of the present invention;

FIG. 2 is a schematic illustration of an air-laid process using wet reinforcement fibers to form a composite material according to at least one exemplary embodiment of the present invention;

FIG. 3 is a schematic illustration of a sandwich composite material where the composite material formed by the process depicted in FIG. 2 is utilized as the outer skin layers according to at least one exemplary embodiment of the present invention; and

FIG. 4 is a schematic illustration of a sandwich composite material where the composite material formed by the process illustrated in FIG. 2 is utilized as the core layer in the sandwich composite material according to at least one exemplary embodiment of the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. It is to be noted that like numbers found throughout the figures denote like elements. The terms “top”, “bottom”, “side”, and the like are used herein for the purpose of explanation only. It will be understood that when an element such as a layer, region, or panel is referred to as being “on” another element, it can be directly on the other element or intervening elements may be present. If an element or layer is described as being “adjacent to” or “against” another element or layer, it is to be appreciated that that element or layer may be directly adjacent to or directly against that other element or layer, or intervening elements may be present. It will also be understood that when an element such as a layer or element is referred to as being “over” another element, it can be directly over the other element, or intervening elements may be present. In addition, the terms “reinforcing fibers” and “reinforcement fibers” may be used interchangeably herein.

The present invention relates to sandwich composite materials that include at least one layer formed of a composite material that includes reinforcing fibers and organic fibers. The composite material may be used as the skin layers or as a core layer in the sandwich composite material.

The reinforcement fibers utilized in the composite material may be any type of organic or inorganic fiber suitable for providing good structural qualities as well as good acoustical and thermal properties. Non-limiting examples of reinforcement fibers that may be utilized in the composite material include glass fibers, wool glass fibers, natural fibers, cellulosic fibers, metal fibers, ceramic fibers, mineral fibers, carbon fibers, graphite fibers, nanofibers, or combinations thereof. The term “natural fiber” as used in conjunction with the present invention refers to plant fibers extracted from any part of a plant, including, but not limited to, the stem, seeds, leaves, roots, or bast. In the composite material, the reinforcement fibers may have the same or different lengths, diameters, and/or denier. Preferably, the reinforcing fibers are glass fibers.

The reinforcement fibers utilized in the composite material may have a length of from approximately about 5 to about 100 mm, and even more preferably, a length of from about 10 to about 50 mm. Additionally, the reinforcing fibers may have diameters of from about 8 to about 25 microns, and preferably have diameters of from about 12 to about 18 microns. The reinforcing fibers may have varying lengths (aspect ratios) and diameters from each other within the composite material. The reinforcing fibers may be present in the composite material in an amount of from about 20 to about 80% by weight of the total fibers, and are preferably present in an amount of from about 40 to about 60% by weight.

In addition, the composite material includes at least one organic fiber. The organic fibers present in the composite material may include polymer based thermoplastic fibers such as, but not limited to, polyester fibers, polyethylene fibers, polypropylene fibers, polyethylene terephthalate (PET) fibers, polyphenylene sulfide (PPS) fibers, polyvinyl chloride (PVC) fibers, ethylene vinyl acetate/vinyl chloride (EVA/VC) fibers, lower alkyl acrylate polymer fibers, acrylonitrile polymer fibers, partially hydrolyzed polyvinyl acetate fibers, polyvinyl alcohol fibers, polyvinyl pyrrolidone fibers, styrene acrylate fibers, polyolefins, polyamides, polysulfides, polycarbonates, rayon, and nylon. The organic fibers may be functionalized with acidic groups, for example, by carboxylating with an acid such as a maleated acid or an acrylic acid, or the organic fibers may be functionalized by adding an anhydride group or vinyl acetate. The organic fibers may alternatively be in the form of a flake, granule, or a powder rather than in the form of a polymer fiber. In some embodiments, a resin in the form of a flake, granule, and/or a powder is added in addition to the organic fibers.

One or more types of organic fibers may be present in the composite material. The organic fibers may have the same or varying lengths, diameters, and/or denier within the composite material. The acoustical behavior, stiffness, load deflection, and strength of the composite material may be tuned by altering the lengths and/or denier of the organic fibers. In addition, the ratio of the different organic fibers present in the composite material can be varied to achieve specific mechanical, acoustic, and thermal properties.

The organic fibers may have a length of from approximately 10 to about 100 mm, and preferably have a length of from about 10 to about 50 mm. Additionally, the organic fibers may have a denier of from about 2 to about 25 denier, preferably from about 2 to about 12 denier. The polymer fibers may be present in the composite material in an amount of from about 20 to about 80% by weight of the total fibers, and are preferably present in an amount of from about 40 to about 60% by weight.

One or more of the organic fibers may be multicomponent fibers such as bicomponent polymer fibers, tricomponent fibers, or plastic-coated mineral fibers such as thermoplastic coated glass fibers. The bicomponent fibers may be arranged in a sheath-core, side-by-side, islands-in-the-sea, or segmented-pie arrangement. Preferably, the bicomponent fibers are formed in a sheath-core arrangement in which the sheath is formed of first polymer fibers that substantially surrounds the core formed of second polymer fibers. It is not required that the sheath fibers totally surround the core fibers. The first polymer fibers have a melting point lower than the melting point of the second polymer fibers so that upon heating the bicomponent fibers, the first and second polymer fibers react differently. In particular, when the bicomponent fibers are heated to a temperature that is above the melting point of the first polymer fibers (sheath fibers) and below the melting point of the second polymer fibers (core fibers), the first polymer fibers will soften or melt while the second polymer fibers remain intact. This softening of the first polymer fibers (sheath fibers) will cause the first polymer fibers to become sticky and bond the first polymer fibers to themselves and other fibers that may be in close proximity.

Numerous combinations of materials can be used to make the bicomponent polymer fibers, such as, but not limited to, combinations using polyester, polypropylene, polysulfide, polyolefin, and polyethylene fibers. Specific polymer combinations for the bicomponent fibers include polyethylene terephthalate/polypropylene, polyethylene terephthalate/polyethylene, and polypropylene/polyethylene. Other non-limiting bicomponent fiber examples include copolyester polyethylene terephthalate/polyethylene terephthalate (coPET/PET), poly 1,4 cyclohexanedimethyl terephthalate/polypropylene (PCT/PP), high density polyethylene/polyethylene terephthalate (HDPE/PET), high density polyethylene/polypropylene (HDPE/PP), linear low density polyethylene/polyethylene terephthalate (LLDPE/PET), nylon 6/nylon 6,6 (PA6/PA6,6), and glycol modified polyethylene terephthalate/polyethylene terephthalate (6PETg/PET).

The bicomponent polymer fibers may have a denier from about 1-18 dernier and a length of from about 2 to about 4 mm. It is preferred that the first polymer fibers (sheath fibers) have a melting point within the range of from about 150 to about 400° F., preferably in the range of from about 170 to about 300° F. The second polymer fibers (core fibers) have a higher melting point, preferably above about 350° F. Bicomponent fibers may be used as a component of the composite material or they may be used as the organic fibers present in the composite material.

The composite material may be formed of an air-laid, wet-laid, or meltblown non-woven mat or web of randomly oriented reinforcement fibers and organic fibers. In at least one exemplary embodiment, the composite material is formed by a dry-laid process, such as the dry-laid process described in U.S. patent application Ser. No. 10/688,013, filed on Oct. 17, 2003, to Enamul Haque entitled “Development Of Thermoplastic Composites Using Wet Use Chopped Strand Glass In A Dry Laid Process”, which is incorporated herein by reference in its entirety. In preferred embodiments, the reinforcing fibers used to form the composite material are wet reinforcing fibers, and most preferably are wet use chopped strand glass fibers. Wet use chopped strand glass fibers for use as the reinforcement fibers may be formed by conventional processes known in the art. It is desirable that the wet use chopped strand glass fibers have a moisture content of from about 5 to about 30%, and more preferably have a moisture content of from about 5 to about 15%.

The use of wet use chopped strand glass fibers provides a cost advantage over conventional dry-laid glass processes. For example, wet use chopped strand glass fibers are less expensive to manufacture than dry chopped fibers such as dry use chopped strand glass fibers (DUCS) because dry fibers are typically dried and packaged in separate steps before being chopped. As a result, the use of wet use chopped strand glass fibers allows the composite material and subsequent sandwich composite material to be manufactured with lower costs.

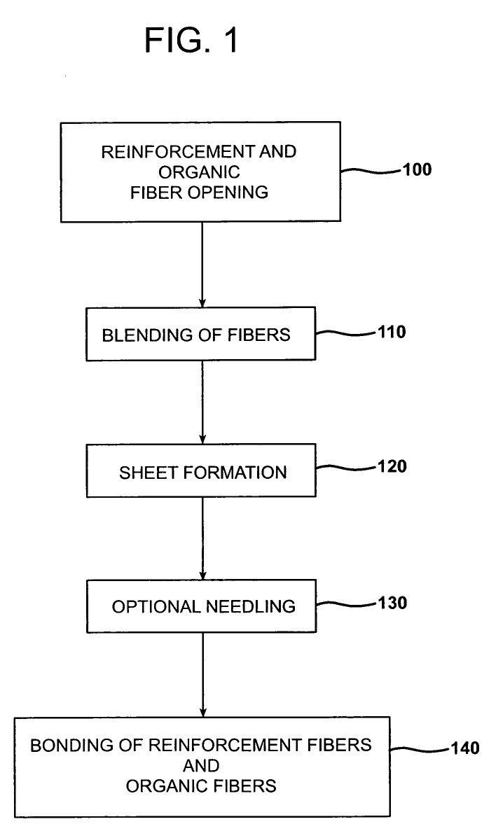

An exemplary process for forming a composite material in accordance with the instant invention is generally illustrated in FIG. 1, and includes at least partially opening the reinforcement fibers and the organic fibers (step 100), blending the reinforcement and organic fibers (step 110), forming the reinforcement and organic fibers into a sheet (step 120), optionally needling the sheet (step 130), and bonding the reinforcement and organic fibers (step 140).

The reinforcing fibers and the organic fibers are typically agglomerated in the form of a bale of individual fibers. Wet glass reinforcing fibers are typically agglomerated in the form of “boxes” of individual fibers. In forming the composite material, bales of reinforcing fibers and organic fibers may be opened by opening systems, such as a bale opening systems, which are common in the industry. The opening system serves both to decouple the clustered fibers and to enhance fiber-to-fiber contact.

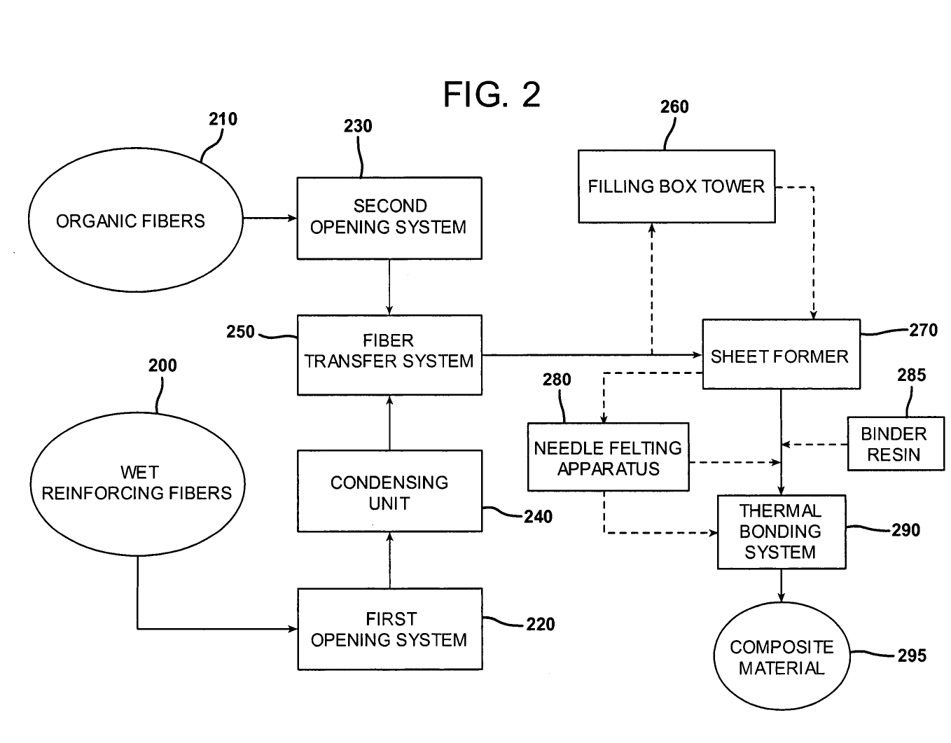

Turning now to FIG. 2, the opening of the wet reinforcement fibers 200 and organic fibers 210 can be seen. Wet reinforcing fibers 200 and organic fibers 210, typically in the form of bales, are fed into a first opening system 220 and a second opening system 230, respectively, to at least partially open and/or filamentize (individualize) the wet reinforcing fibers 200 and organic fibers 210. Although the exemplary process depicted in FIGS. 1 and 2 show opening the organic fibers 210 by a second opening system 230, the organic fibers 210 may be fed directly into the fiber transfer system 250 (embodiment not illustrated) if the organic fibers 210 are present or obtained in a filamentized form, and are not in the form of a bale. Such an embodiment is considered to be within the purview of this invention.

In alternate embodiments where the organic fibers 210 are in the form of a flake, granule, or powder (not illustrated) and not in a fibrous form, the second opening system 230 may be replaced with an apparatus suitable for distributing the flakes, powders, or granules to the fiber transfer system 250 so that these resinous materials may be mixed with the reinforcement fibers 200. A suitable distribution apparatus would be easily identified by those of skill in the art. In embodiments where a resin in the form of a flake, granule, or powder is used in addition to the organic fibers 210 (and not in place of), the apparatus distributing the flakes, granules, or powder may not need to replace the second opening system 230.

The first and second opening systems 220, 230 are preferably bale openers, but may be any type of opener suitable for opening the bales of wet reinforcement fibers 200 and organic fibers 210. The design of the openers depends on the type and physical characteristics of the fiber being opened. Suitable openers for use in the present invention include any conventional standard type bale openers with or without a weighing device. The weighing device serves to continuously weigh the partially opened fibers as they are passed through the bale opener to monitor the amount of fibers that are passed onto the next processing step. The bale openers may be equipped with various fine openers, one or more licker-in drums or saw-tooth drums, feeding rollers, and/or or a combination of a feeding roller and a nose bar.

The partially opened wet reinforcement fibers 200 may then be dosed or fed from the first opening system 220 to a condensing unit 240 to remove water from the wet fibers. In exemplary embodiments, greater than about 70% of the free water (water that is external to the reinforcement fibers) is removed. Preferably, however, substantially all of the water is removed by the condensing unit 240. It should be noted that the phrase “substantially all of the water” as it is used herein is meant to denote that all or nearly all of the free water is removed. The condensing unit 240 may be any known drying or water removal device known in the art, such as, but not limited to, an air dryer, an oven, rollers, a suction pump, a heated drum dryer, an infrared heating source, a hot air blower, or a microwave emitting source.

After the reinforcement fibers 200 have passed through the condensing unit 240, the fibers may be passed through another opening system, such as a bale opener as is described above, to further filamentize and separate the reinforcement fibers 200 (embodiment not shown).

The reinforcing fibers 200 and the organic fibers 210 may be blended together by a fiber transfer system 250. In preferred embodiments, the fibers are blended in a high velocity air stream. The fiber transfer system 250 serves both as a conduit to transport the reinforcing fibers 200 and organic fibers 210 to a sheet former 270 and to substantially uniformly mix the reinforcing fibers 200 and organic fibers 210. It is desirable to distribute the reinforcing fibers 200 and organic fibers 210 as uniformly as possible. The ratio of reinforcing fibers 200 and organic fibers 210 entering the fiber transfer system 250 may be controlled by a weighing device such as described above with respect to the first and second opening systems 220, 230 or by the amount and/or speed at which the fibers are passed through the first and second opening systems 220, 230. In preferred embodiments, the ratio of reinforcing fibers 200 to organic fibers 210 present in the air stream is 50:50, reinforcement fibers 200 to organic fibers 210 respectively. However, it is to be appreciated that the ratio of fibers present within the air stream will vary depending on the desired structural and acoustical requirements of the final product.

In some embodiments of the invention, other types of fibers such as chopped roving, dry use chopped strand glass (DUCS), natural fibers (such as jute, hemp, and kenaf), aramid fibers, metal fibers, ceramic fibers, mineral fibers, carbon fibers, graphite fibers, polymer fibers, or combinations thereof may be opened and filamentized by additional openers (not shown), added to the fiber transport system 250, and mixed with the reinforcement fibers 200 and organic fibers 210, depending on the desired composition of the composite material. When such additional fibers are added, up to approximately 25% of the fibers in the fiber transfer system 250 consist of these additional fibers.

The mixture of reinforcing fibers 200 and organic fibers 210 exiting the fiber transfer system 250 may be transferred to a sheet former 270 where the fibers are formed into a sheet. The blended fibers may be transported by the fiber transfer system 250 to a filling box tower 260 where the reinforcing fibers 200 and organic fibers 210 are volumetrically fed into the sheet former 270, such as by a computer monitored electronic weighing apparatus, prior to entering the sheet former 270. The filling box tower 260 may be located internally in the sheet former 270 or it may be positioned external to the sheet former 270. The filling box tower 260 may also include baffles to further blend and mix the reinforcement fibers 200 and organic fibers 210 prior to entering the sheet former 270. In one exemplary embodiment (not shown), the mixture of reinforcing fibers 200 and organic fibers 210 are blown onto a drum or series of drums covered with fine wires or teeth to comb the fibers into parallel arrays prior to entering the sheet former 260 (not illustrated), as in a carding process.

In addition, the sheet formed by the sheet former 270 may be transferred to a second sheet former (not shown). The second sheet former assists in distributing the reinforcement fibers 200 and organic fibers 210 in the sheet. The use of an additional sheet former may increase the structural integrity of the formed sheet.

In some embodiments, a sheet former 270 having a condenser and a distribution conveyor may be used to achieve a higher fiber feed into the filling box tower 260 and an increased volume of air through the filling box tower 260. In order to achieve an improved cross-distribution of the opened fibers, the distributor conveyor may run transversally to the direction of the sheet. As a result, the reinforcement fibers 200 and the organic fibers 210 may be transferred into the filling box tower 260 with little or no pressure and minimal fiber breakage. In at least one exemplary embodiment, the length of the organic fibers 210 is substantially the same length as the reinforcement fibers 200. The substantially similar length of the reinforcement and organic fibers 200, 210 assists in uniformly distributing the fibers during the mixing of the reinforcing fibers 200 and organic fibers 210 in the fiber transfer system 250, filling box tower 260, and sheet former 270.

The sheet formed by the sheet former 270 contains a substantially uniform distribution of reinforcing fibers 200 and organic fibers 210 at a desired ratio and weight distribution. The sheet formed by the sheet former 270 may have a weight distribution of from 400-2500 g/m², with a preferred weight distribution of from about 1000 to about 2000 g/m².

In one or more embodiments of the invention, the sheet exiting the sheet former 270 is subjected to a needling process in a needle felting apparatus 280 in which barbed or forked needles are pushed in a downward and/or upward motion through the fibers of the sheet to entangle or intertwine the reinforcing fibers 200 and organic fibers 210 and impart mechanical strength and integrity to the mat. The needle felting apparatus 280 may include a web feeding mechanism, a needle beam with a needleboard, barbed felting needles ranging in number from about 500 per meter to about 7,500 per meter of machine width, a stripper plate, a bed plate, and a take-up mechanism. Mechanical interlocking of the reinforcement fibers 200 and organic fibers 210 is achieved by passing the barbed felting needles repeatedly into and out of the sheet. An optimal needle selection for use with the particular reinforcement fibers 200 and organic fibers 210 chosen for use in the inventive process would be easily identified by one of skill in the art.

Either after the sheet exits the sheet former 270 or after the optional needling of the sheet, the sheet may be passed through a thermal bonding system 290 to bond the reinforcement fibers 200 and organic fibers 210. In thermal bonding, the thermoplastic properties of the organic fibers 210 are used to form bonds with the reinforcement fibers 200 upon heating. In the thermal bonding system 290, the sheet is heated to a temperature that is above the melting point of the organic fibers 210 but below the melting point of the reinforcement fibers 200. When bicomponent fibers are used as the organic fibers 210, the temperature in the thermal bonding system 290 is raised to a temperature that is above the melting point of the sheath fibers, but below the melting point of the reinforcement fibers 200. Heating the organic fibers 210 to a temperature above their melting point, or above the melting point of the sheath fibers in the instance where the organic fibers 210 are bicomponent fibers, causes the organic fibers 210 (or sheath fibers) to become adhesive and bond the organic fibers 210 and reinforcing fibers 200. If the organic fibers 210 completely melt, the melted fibers may encapsulate the reinforcement fibers 200. As long as the temperature within the thermal bonding system 290 is not raised as high as the melting point of the reinforcing fibers 200 and/or core fibers, these fibers will remain in a fibrous form within the thermal bonding system 290 and composite material 295.

Although the organic fibers 210 may be used to bond the reinforcement fibers 200 to each other, a thermoplastic or thermosetting binder resin 285 may be added to assist in the bonding of the fibers prior to passing the sheet through the thermal bonding system 290. The binder resin 285 may be in the form of a resin powder, flake, granule, foam, or liquid spray. The binder resin 285 may be added to the sheet by any suitable manner, such as, for example, a flood and extract method or by spraying the binder resin 285 onto the sheet. The amount of binder resin 285 added to the sheet may be varied depending on the desired characteristics of the composite material 295. A catalyst such as ammonium chloride, p-toluene, sulfonic acid, aluminum sulfate, ammonium phosphate, or zinc nitrate may also be used to improve the rate of curing and the quality of the cured binder resin 285.

Another process that may be employed to further bond the reinforcing fibers 200 and organic fibers 210 either alone, or in addition to, the other bonding methods described herein, is latex bonding. In latex bonding, polymers formed from monomers such as ethylene (T_{g}−125° C.), butadiene (T_{g}−78° C.), butyl acrylate (T_{g}−52° C.), ethyl acrylate (T_{g}−22° C.), vinyl acetate (T_{g} 30° C.), vinyl chloride (T_{g} 80° C.), methyl methacrylate (T_{g} 105° C.), styrene (T_{g} 105 C°), and acrylonitrile (T_{g} 130° C.) are used as bonding agents. A lower glass transition temperature (T_{g}) results in a softer polymer. Latex polymers may be added as a spray prior to the sheet entering the thermal bonding system 290. Once the sheet enters the thermal bonding system 290, the latex polymers melt and bond the reinforcement fibers 200 and organic fibers 210.

A further optional bonding process that may be used alone, or in combination with the other bonding processes described herein, is chemical bonding. Liquid based bonding agents, powdered adhesives, foams, and, in some instances, organic solvents may be used as the chemical bonding agent. Suitable examples of chemical bonding agents include, but are not limited to, acrylate polymers and copolymers, styrene-butadiene copolymers, vinyl acetate ethylene copolymers, and combinations thereof. For example, polyvinyl acetate (PVA), ethylene vinyl acetate/vinyl chloride (EVANC), lower alkyl acrylate polymer, styrene-butadiene rubber, acrylonitrile polymer, polyurethane, epoxy resins, polyvinyl chloride, polyvinylidene chloride, and copolymers of vinylidene chloride with other monomers, partially hydrolyzed polyvinyl acetate, polyvinyl alcohol, polyvinyl pyrrolidone, polyester resins, and styrene acrylate may be used as a chemical bonding agent. The chemical bonding agent may be applied uniformly by impregnating, coating, or spraying the sheet.

The thermal bonding system 290 may include any known heating and bonding method known in the art, such as oven bonding, oven bonding using forced air, infrared heating, hot calendaring, belt calendaring, ultrasonic bonding, microwave heating, and heated drums. Optionally, two or more of these bonding methods may be used in combination to bond the fibers in the sheet. The temperature of the thermal bonding system 290 varies depending on the melting point of the organic fibers 210 used and whether or not bicomponent fibers are present in the sheet. The composite material 295 that emerges from the thermal bonding system 290 contains a uniform or nearly uniform distribution of organic fibers 210 and reinforcement fibers 200. The uniform or nearly uniform distribution of reinforcement fibers 200 and organic fibers 210 in the composite material 295 provides improved strength, improved acoustical and thermal properties, improved stiffness, improved load deflection, and improved impact resistance to the sandwich composite material. In addition, the composite material 295 has substantially uniform weight consistency, which results in uniform properties such as flexural and impact strength in the sandwich composite material.

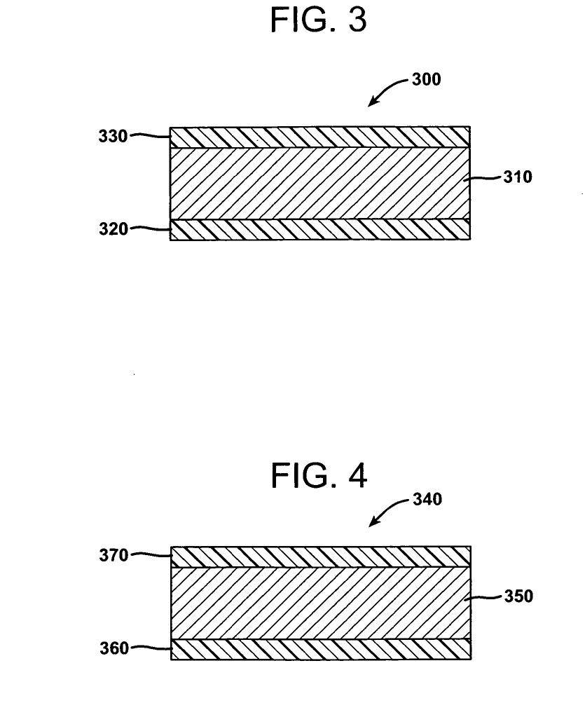

A sandwich composite material 300 that includes a core layer 310 positioned between a first skin layer 320 and a second skin layer 330 is illustrated in FIG. 3. It is to be appreciated that each of the first and second skin layers 320, 330 are formed of a composite material 295 produced by the above-described process depicted in FIGS. 1 and 2, and that these layers may be formed of the same composite material 295 or different composite materials 295.

As described above, the sandwich composite material 300 includes a core layer 310 positioned between major surfaces of the first and second skin layers 320, 330. Suitable components for use in the core layer 310 include, but are not limited to, polyurethane foams, polystyrene, polyvinyl chloride, polyolefins (such as polypropylene, polyethylene), polycarbonate, polymethyl metharylamide, styrene acrylonitrile (SAN) copolymer, polyethyerimide foam, polyetherimide/polysulphone foam, balsa wood of varying weights, paper, cardboard, aluminum, nomex, glass reinforced thermoplastics, and combinations thereof. Physical properties of the sandwich composite material 300 such as strength, stiffness, and load distribution may be altered or tailored to meet specific requirements by altering the weight, K-value, thickness and/or type of foam or by the specific type of other core material used (such as balsa weight) in the core layer 310.

The core layer 310 may be attached to the first and second skin layers 320, 330 by adhesives (such as spray-on adhesives, pressure sensitive adhesives, temperature sensitive adhesives) or resin tie layers. Non-limiting examples of suitable resin tie layers include Plexar™ (commercially available from Quantum Chemical), Admer™ (commercially available from Mitsui Petrochemical), and Bynel™ (an anhydride modified polyolefin commercially available from DuPont). Other commonly known fixation technologies such as ultrasonics or vibration welding may be used to affix the core layer 310 to the first and second skin layers 320, 330. Alternatively, the core layer 310 and the first and second skin layers 320, 330 may attached by twin sheet thermoforming of the different layers.

In addition, the sandwich composite material 300 may include a facing layer or surface covering (not illustrated) affixed to an exposed major surface one or both of the first and second skin layers 320, 330. The surface covering may be formed of fabrics, wall paper, vinyl, leather, aluminum foil, thin copper sheets, thermoplastic olefins (TPO), or films having various constructions, including monolayer films such as polypropylene, polyethylene, and polyamide, or multilayer films such as ethylene/acrylic acid (EAA), ethylene vinyl acetate (EVA), and polypropylene/polyamide (PP/PA). The surface layer may assist in altering the acoustical properties of the sandwich composite material 300 so that it can be tuned to meet the needs of a particular application. In addition, depending on the material of the surface layer, the surface layer may provide other properties of the sandwich composite material such as, but not limited to, water permeability or non-permeability, abrasion resistance, and/or heat resistance.

In an alternate embodiment illustrated in FIG. 4, a composite material 295 formed by the above-described process depicted in FIGS. 1 and 2 is utilized as a core layer 350 in a sandwich composite material 340. The core layer 350 is surrounded by first and second skin layers 360, 370. The first and second skin layers 360, 370 may be formed of high strength composites sheets such as, but not limited to, sheet molding compounds (SMC), bulk molding compounds (BMC), glass mat reinforced thermoplastics (GMT), carbon fiber reinforced sheets, natural fiber reinforced sheets, metallic sheets of thin aluminum, and copper. In addition, the first and second skin layers 360, 370 may be formed of polymer sheets such as polypropylene, polyethylene, polycarbonate, acrylonitrile-butadiene-styrene (ABS), a polycarbonate/polyester-based plastic substrate (sold under the tradename Xenoy™ by General Electric Company), polyetherimides (sold under the tradename Ultem™ by General Electric Company), and polyphenylene oxide (sold as Noryl™ by General Electric Company). The first and second skin layers 360, 370 may be formed of the same material or different materials. The core layer 350 formed of the composite material 295 provides good insulation, physical, and dynamic properties that makes the sandwich composite material 340 ideal for applications where shock and impact loads are experienced. As described above with respect to FIG. 3, the core layer 350 and the first and second skin layers 360, 370 may be affixed to each other by adhesives, resin tie layers, ultrasonics, vibration welding, or by sheet thermoforming the layers. In addition, a facing layer (not shown) may be affixed to an exposed major surface of one or both of the first and second skin layers 360, 370.

The use of a composite material 295 to form the first and second skin layers 320, 330 (FIG. 3) or the core layer 350 (FIG. 4) provides manufactures the ability to optimize the physical properties of the sandwich composite material (strength, stiffness, and load deflection) by altering the amount and/or type of the reinforcing fibers and/or organic fibers used in the composite material. In addition, the strength, stiffness, and load deflection of the sandwich composite material may be optimized by altering the weight of the reinforcement and/or organic fibers, by changing the reinforcement fiber content and/or length or diameter of the reinforcement fibers, or by altering the fiber length and/or denier of the organic fibers used in the composite material. Thus, the strength, stiffness, load deflection, and acoustic requirements (if any) of the sandwich composite material may be altered or improved by the specific combination of fibers present in the composite material, and the sandwich composite material can therefore be tailored to meet the needs of a particular application.

The sandwich composite materials 300 and 340 may be formed by sequentially depositing a first skin layer, an adhesive or tie layer, a core layer, another adhesive or tie layer, and a second skin layer. The sandwich composite material may then be laminated, such as by using a laminator or other type of moving belt press. The sandwich composite material may be compression molded or thermoformed into various shapes. For example, the skin layers may be thermoformed into desired shapes in a twin sheet thermoformer by heating the skin layers and forming the shape using vacuum and/or pressure forming. The core layer, along with the thermoformed skin layers, is pressure formed. The sandwich composite material may be molded or die-cut to form a desired acoustical, semi-structural final part in a one step process. The process of manufacturing sandwich composite materials may be conducted either in-line (in a continuous manner), or in individual steps. Preferably, the process is conducted in-line. Moreover, any additional process steps such as adding specialty films, scrims, and/or other fabrics are considered to be within the scope of the invention.

The sandwich composite material may be utilized in numerous structural applications such as in forming transportation loadfloors, seatbacks, and in other applications in the consumer and building industry. The sandwich composite material may also be used as office partition boards and sound absorbing panels in homes, such as in basement finishing systems.

The thickness of the formed composite part, porosity of the formed composite part (void content), and the air flow path may be controlled by changing the basis weight of the organic fibers and/or glass content of the composite material. Additionally, the use of wet glass chopped strand glass in the dry-laid process as described above with respect to FIGS. 1 and 2 contributes to the improved sound absorption of the inventive composite material because the composite material formed by the dry-laid process has a higher loft (increased porosity). In addition, composite materials formed by the processes described herein have a uniform or substantially uniform distribution of reinforcement and organic fibers, thereby providing improved strength as well as improved acoustical and thermal properties, stiffness, and impact resistance.

It is another advantage of the present invention that when wet use chopped strand glass fibers are used as the reinforcing fibers, the glass fibers may be easily opened and fiberized with little generation of static electricity due to the moisture present in the glass fibers. In addition, wet use chopped strand glass fibers are less expensive to manufacture than dry chopped fibers because dry fibers are typically dried and packaged in separate steps before being chopped. Therefore, the use of wet use chopped strand glass fibers allows the composite product (and sandwich composite material) to be manufactured with lower costs.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A method of forming a sandwich composite material comprising the steps of:
positioning a core layer between major surfaces of a first skin layer and a second skin layer, said first and second skin layers each being formed of a composite material comprising dehydrated reinforcing fibers and organic fibers, and
affixing said core layer to each of said first skin layer and said second skin layer to form a sandwich composite material.

2. The method according to claim 1, wherein said core layer is selected from the group consisting of polyurethane foams, polystyrene, polyvinyl chloride, polyolefins, polycarbonate, polymethyl metharylamide, styrene acrylonitrile copolymer, polyethyerimide foam, polyetherimide/polysulphone foam, balsa wood, paper, cardboard, aluminum, nomex, glass reinforced thermoplastics and combinations thereof.

3. The method of claim 1, further comprising the step of forming said composite material prior to said positioning step, said forming step including:
removing water from wet reinforcing fibers to form dehydrated reinforcing fibers;
blending said dehydrated reinforcing fibers with said organic fibers to form a substantially homogenous mixture of said dehydrated reinforcing fibers and said organic fibers;
forming said mixture into a sheet; and
bonding at least some of said dehydrated reinforcing fibers and said organic fibers to form said composite material.

4. The method of claim 3, further comprising the step of:
at least partially opening bales of wet reinforcing fibers prior to said removing step.

5. The method of claim 3, wherein said wet reinforcing fibers are wet use chopped strand glass fibers.

6. The method of claim 1, further comprising the step of:
attaching a facing layer to an exposed major surface one or both of said first and second skin layers.

7. The method of claim 1, wherein said core layer is affixed to said first and second skin layers by a member selected from the group consisting of adhesives, resin tie layers, ultrasonics and vibration welding.

8. A method of forming a sandwich composite material comprising the steps of:
positioning a core layer between major surfaces of a first skin layer and a second skin layer, said core layer being formed of a composite material including dehydrated reinforcement fibers and organic fibers, and
affixing said core layer to each of said first skin layer and said second skin layer to form a sandwich composite material.

9. The method of claim 8, further comprising the step of forming said composite material prior to said positioning step, said forming step including:
at least partially opening bales of wet reinforcement fibers;
removing water from said at least partially opened bales of wet reinforcement fibers to form dehydrated reinforcement fibers;
blending said dehydrated reinforcement fibers with said organic fibers to form a substantially homogenous mixture of said dehydrated reinforcement fibers and said organic fibers;
forming said mixture into a sheet; and
bonding at least some of said dehydrated reinforcement fibers and said organic fibers to form said composite material.

10. The method of claim 9, wherein said wet reinforcement fibers are wet use chopped strand glass fibers.

11. The method of claim 8, further comprising the step of:
attaching a facing layer to an exposed major surface one or both of said first and second skin layers.

12. The method of claim 8, wherein said first and second skin layers are formed of sheet molding compounds, bulk molding compounds, glass mat reinforced thermoplastics, carbon fiber reinforced sheets, natural fiber reinforced sheets, metallic sheets, polypropylene, polyethylene, polycarbonate, xenoy, acrylonitrile-butadiene-styrene, polyethererimides and polyphenylene oxide.

13. A sandwich composite material comprising:
a first skin layer having a first major surface and a second major surface;
a second skin layer having a first major surface and a second major surface; and
a core layer positioned between said first and second skin layers such that said first major surfaces of said first and second skin layers are located adjacent to said core layer;
wherein each of said first and second skin layers or said core layer is a composite material that includes dehydrated reinforcement fibers and organic fibers.

14. The sandwich composite material of claim 13, wherein when said first and second skin layers are formed of said composite material and said core layer is a member selected from the group consisting of polyurethane foams, polystyrene, polyvinyl chloride, polyolefins, polycarbonate, polymethyl metharylamide, styrene acrylonitrile copolymer, polyethyerimide foam, polyetherimide/polysulphone foam, balsa wood, paper, cardboard, aluminum, nomex and glass reinforced thermoplastics.

15. The sandwich composite material of claim 14, wherein said composite material forming said first skin layer and said composite material forming said second skin layer are the same.

16. The sandwich composite material of claim 13, wherein when said core layer is formed of said composite material, said first and second skin layers are selected from the group consisting of sheet molding compounds, bulk molding compounds, glass mat reinforced thermoplastics, carbon fiber reinforced sheets, natural fiber reinforced sheets, metallic sheets, polypropylene, polyethylene, polycarbonate, xenoy, acrylonitrile-butadiene-styrene, polyethererimides and polyphenylene oxide.

17. The sandwich material of claim 13, further comprising:
a facing layer affixed to at least one of said second major surfaces of said first and second skin layers.

18. The sandwich material of claim 13, wherein said core layer is affixed to said first surfaces of said first and second skin layers by a member selected from the group consisting of adhesives, resin tie layers, ultrasonics and vibration welding.
